(19) United States
(12) Patent Application Publication
(10) Pub. No.: US 2008/0046322 A1
(43) Pub. Date: Feb. 21, 2008

(54) GENERATION OF A REBATE TO A USER OF A BUSINESS

(75) Inventor: Craig Langdon Reinhart, Houston, TX (US)

Correspondence Address: DARBY & DARBY P.C., P.O. BOX 770, Church Street Station, New York, NY, 10008-0770, US

(73) Assignee: Random Generation Marketing LLC, Houston, TX (US)

(21) Appl. No.: 11/838,121

(22) Filed: Aug. 13, 2007

Related U.S. Application Data
(60) Provisional application No. 60/837,841, filed on Aug. 15, 2006.

(51) Int. Cl. G06Q 30/00

(52) U.S. Cl. 705/14

(57) ABSTRACT

A client device, system, and method are directed towards enabling a business to randomly select an existing client to receive a rebate based, in part, on a portion of transactions by a plurality of clients with the business. In one embodiment, the business selects a rebate percentage and a mechanism for randomly selecting at least one client from the plurality of existing clients. In one embodiment, the clients actively employ a service, purchase products, or perform other transactions with the business. In one embodiment, the business may charge a fee for the service, product, or transaction. In one embodiment, at least a portion of the fees obtained from the plurality of existing clients may be used to reward at least one of the clients. As a defined time, a selected client may receive the rebate, whereby another client may be randomly selected to receive a different rebate.

### CROSS REFERENCE TO RELATED APPLICATIONS

This application claims the benefit of U.S. Provisional Application Ser. No. 60/837,841, entitled “Random Generation Marketing,” filed on Aug. 15, 2006, the benefit of the earlier filing date of which is hereby claimed under 35 U.S.C. §119 (e) and further incorporated by reference.

### TECHNICAL FIELD

The present invention relates generally to managing transactions over a network and, more particularly, but not exclusively to enabling a business to manage client transactions by using a marketing mechanism in which an existing client may be randomly selected to receive a rebate based, in part, on transactions by a plurality of clients of the business.

### BACKGROUND

Advertising is a fast-paced multi-billion dollar industry. In the advertising industry, the advantages of presenting attractive, attention-getting, advertisements and other marketing materials are well recognized. Such advertisements or similar marketing techniques enable a business to increase brand recognition, improve sales, build customer loyalty, and to generate greater revenue.

Often, consumers select a business based on cost and/or name recognition. Therefore, lesser known businesses may find it necessary to cut costs as much as possible to provide consumers with the lowest bottom line pricing, to compete with better known companies. Alternatively, the lesser known businesses might attempt to spend more in advertising their brand. However, such lesser known businesses may be unable to outspend a larger company in advertisements to obtain a well known name in the marketplace. Moreover, businesses might spend large amounts of money advertising to persons potentially not interested in the businesses' services, products, or the like. To survive in the marketplace, companies continually seek alternative approaches to becoming well known, marketing to the appropriate consumers, generating customer loyalty, and improving sales. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a client device that may be included in a system implementing the invention

FIG. 3 shows one embodiment of a network device that may be included in a system implementing the invention;

FIG. 4 shows one embodiment of a possible architecture for a marketing manager; and

FIG. 5 illustrates a logical flow diagram generally showing one embodiment of a process for randomly selecting a user of a business to receive a rebate based, in part, on the user's usage of the business.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “rebate” includes commissions, refunds, incentives, payouts, supplements, and similar mechanisms related to providing a client with a reward for participation and/or purchase of a product, a service, or performing some other transaction with a business.

Briefly stated the present invention is directed towards enabling a business to randomly select an existing client to receive a rebate based, in part, on a portion of transactions by a plurality of clients with the business. In one embodiment, the business selects a rebate percentage, or other payout structure, and a mechanism for randomly selecting at least one client from the plurality of existing clients. In one embodiment, the clients actively employ a service, purchase products, or perform other transactions with the business. In one embodiment, the business may charge a fee for the service, products, or transactions. In one embodiment, at least a portion of the fees obtained from the plurality of existing clients may be used to reward at least one of the clients. In one embodiment, the portion of fees may more generally included as a portion of revenues generated by the purchase of the service, product, or transaction by the client(s). Thus, revenues may include fees, as used herein.

Selection of the at least one client may be based on a variety of criteria, including a duration over which the client has performed transactions with the business, a number of other clients that have selected to perform transactions subsequent to participation by the client, or the like. For example, in one embodiment, clients that have participated in transactions for more than a period of time might be selected as a subgroup from which one or more clients might then be randomly selected to receive the rebate. In another embodiment, clients that make purchases over a defined amount of money might also be defined as a subgroup from which one or more clients might then be selected to receive the rebate. In still another embodiment, a number might be randomly selected that may be used to identify one or more clients. For example, the number might indicate a single client, or might indicate that every Nth client might receive the rebate, where N is the randomly selected number. It should be noted, however, that the invention is not limited to these selection criteria, and virtually any criteria might be employed to identify clients from which one or more clients might be then randomly selected to receive the rebate. By providing a rebate to randomly selected clients of a business based on more than merely the transactions of the selected client, the business may be likely enabled to provide an increased incentive for persons to participate in transactions with the business, increase customer loyalty and thereby decrease customer attrition, and improve referrals for new customers through existing client's “word of mouth” advertising. Potential users may also have a sense of urgency to register to be selected for receiving a rebate, as the amount might, in at least one embodiment, be based on when a user registers, or otherwise participates. Moreover, the business may be able to decrease money spent on advertisements to ‘non-interested’ parties. In addition, use of the present invention is directed towards reducing the incentive of customers that may switch between businesses based on “initial sign-up offers,” and similar initial incentive marketing approaches.

### Illustrative Operating Environment

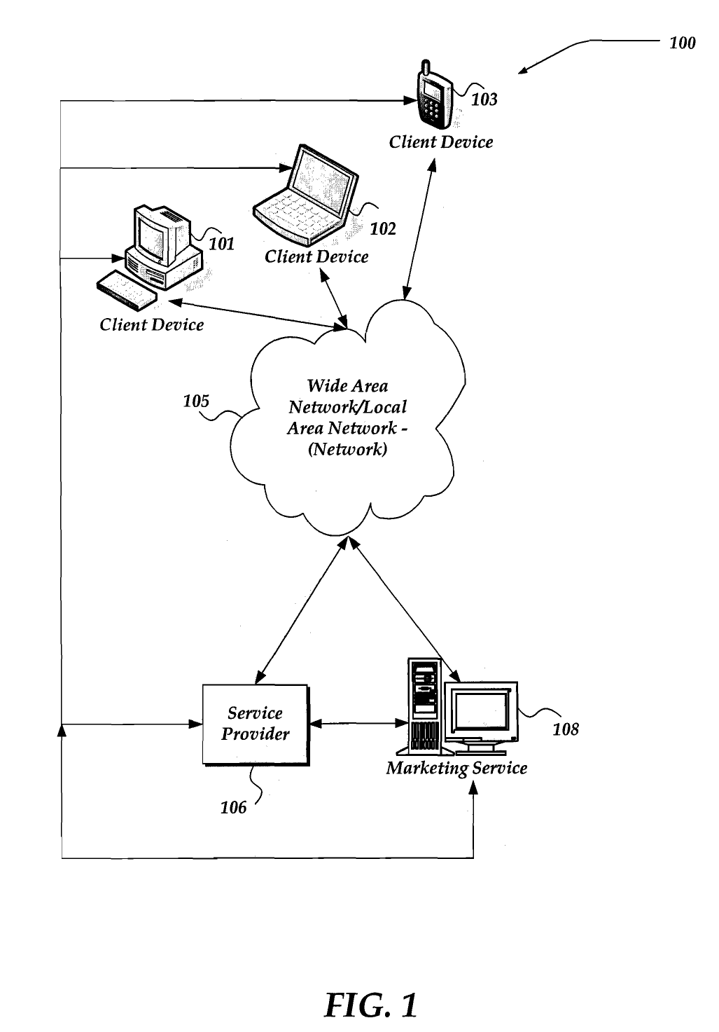

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 105, client devices 101-103, service provider 106, and marketing service 108.

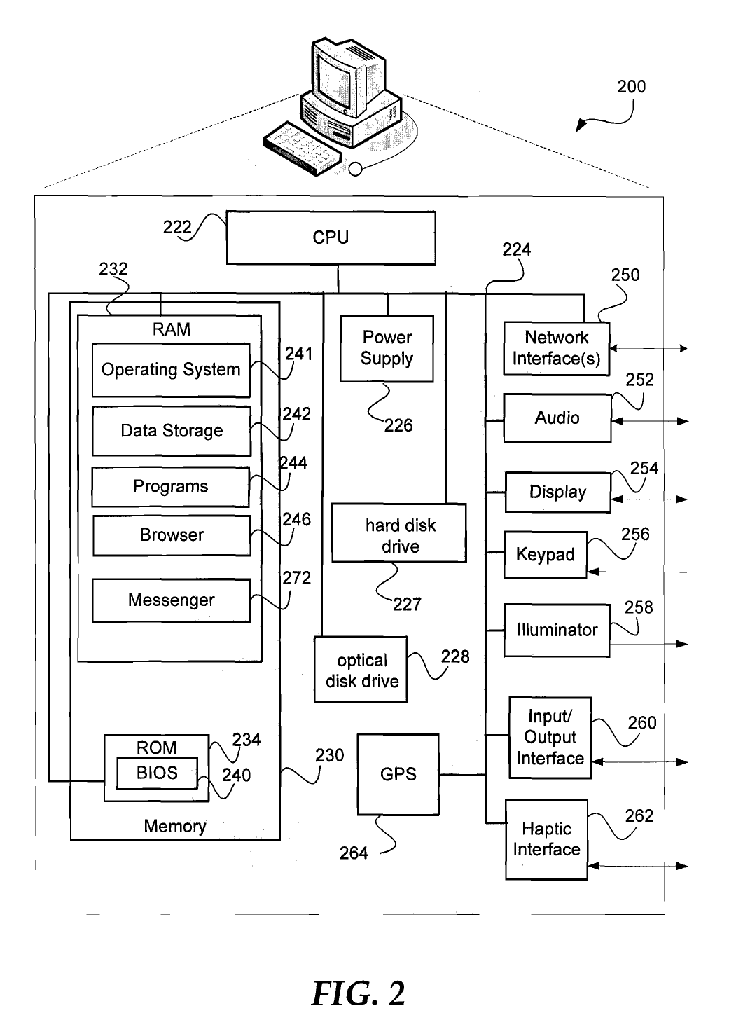

One embodiment of client devices 101-103 is described in more detail below in conjunction with FIG. 2. Generally, client devices 101-103 may include virtually any computing device capable of connecting to another computing device to send and receive information, including web requests for information from a server, providing content, requesting purchases of a product, a service, or for performing other transactions. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, radio frequency (RF) devices, infrared (IR) devices, integrated devices combining one or more of the preceding devices, or virtually any network device. Similarly, client devices 101-103 may be any device that is capable of connecting using a wired or wireless communication medium such as a PDA, POCKET PC, wearable computer, and any other device that is equipped to communicate over a wired and/or wireless communication medium.

Client devices 101-103 may also include a client application that may be configured to provide information that identifies itself, including a type, capability, name, and the like. Client devices 101-103 may identify themselves through any of a variety of mechanisms, including a phone number, Mobile Identification Number (MIN), an electronic serial number (ESN), or a network address, such as an Internet Protocol (IP) address, or other network address identifier. In one embodiment, client devices 101-103 may be configured to provide such network address identifier in a message, or the like, sent over network 105 to another computing device.

Client devices 101-103 may further include a client application that is configured to manage various actions. For example, client devices 101-103 may include a web browser application that is configured to enable an end-user to interact with other devices and/or applications over network 105. For example, client devices 101-103 may enable use of the web browser to access content, web pages, or the like, from another computing device, such as content servers 107-109, or the like. In one embodiment, client devices 101-103 may receive a script, applet, application, or the like, that may be configured to operate in conjunction with the web browser application. Through the user of client devices 101-103 and the client application, a user may request a purchase from a service provider, such as service provider 106. Moreover, in one embodiment, the user of client devices 101-103 may also provide payments for the purchase, and/or receive a reward for participation with service provider 106.

In addition, client devices 101-103 may employ a variety of other client applications to communicate with other devices over network 105, including, but not limited to Voice Over Internet Protocol (VOIP), Instant Messaging (IM), Short Message Service (SMS), Multimedia Message Service (MMS), email, or the like. Thus, client devices 101-103 may employ a variety of mechanisms to establish network sessions with another computing device.

Network 105 is configured to couple one computing device with another computing device to enable them to communication information. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between one computing device and another computing device.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Service provider 106 represents virtually any business that may operate to provide a presence over network 105 and/or elsewhere. As such, service provider 106 may represent a merchant website that enables a user to perform various purchase transactions over network 105. In another embodiment, service provider 106 may also provide various services that may be purchased by a user. For example, in one embodiment, service provider 106 may operate to enable a user to register for services that include, but are not limited, to internet access services, news report services, audio downloads, video downloads, or the like. However, service provider 106 is not limited to merely network provided services, and other services and/or products may also be provided. For example, a user may access service provider 106 over network 105 to sign up to receive a telephone service, an electric power service to their home, a water service to their home, insurance, or the like. Clearly, it should be apparent that the types of products, and/or services that service provider 106 may provide are virtually unlimited. For example, service provider 106 may even, in one embodiment, be configured to enable legalized on-line gambling, without departing from the scope of the invention.

In one embodiment, service provider 106 may be configured to operate a website. However, service provider 106 is not limited to web servers, and may also operate a messaging server, a File Transfer Protocol (FTP) server, a database server, content server, and the like. Additionally, service provider 106 may be configured to perform multiple operations. Thus, for example, service provider 106 may be configured as a website, and also may be configured as music or video download server.

Devices that may operate as content servers 107-109 include personal computers desktop computers, multiprocessor systems, microprocessor-based or programmable consumer electronics, network PCs, servers, and the like.

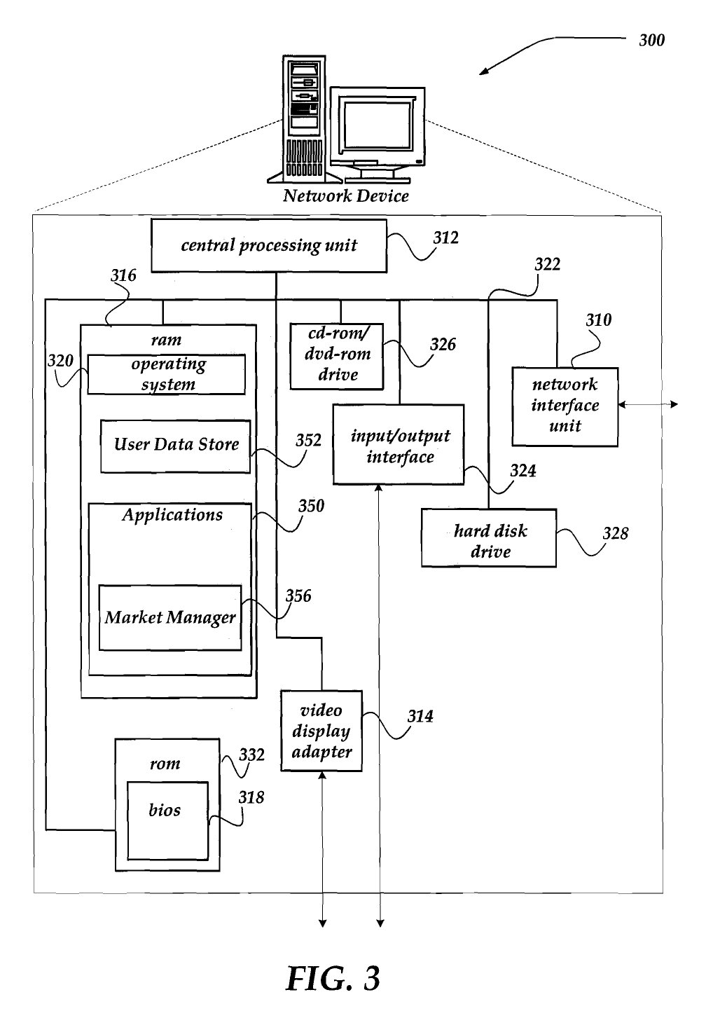

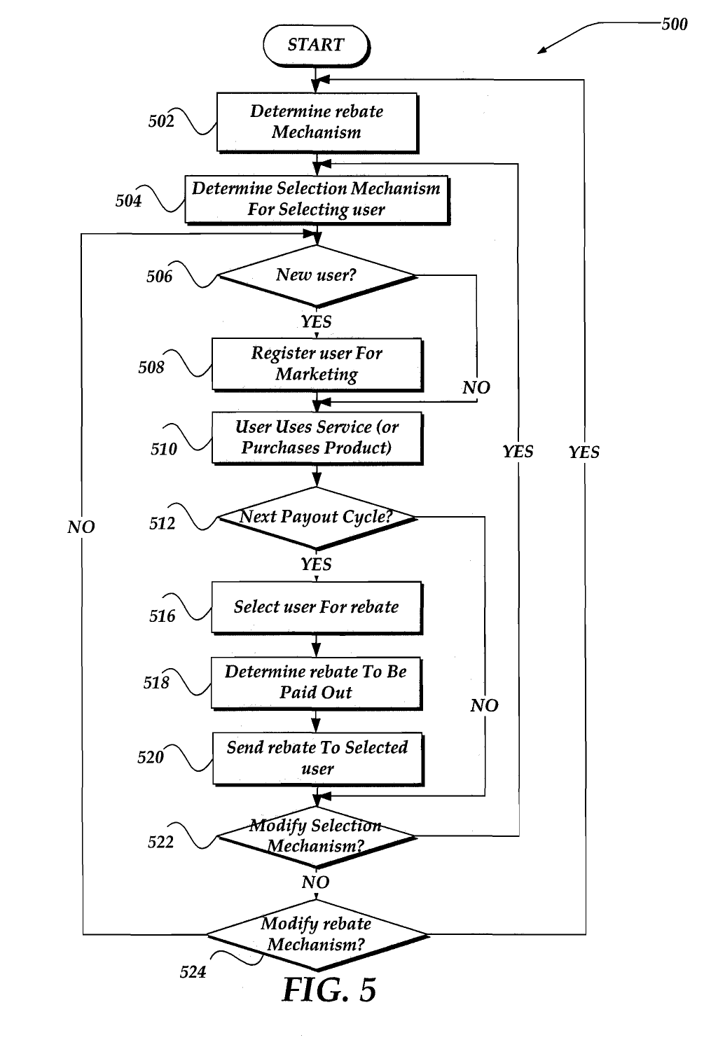

One embodiment of marketing service 108 is described in more detail below in conjunction with FIG. 3. Briefly, however, marketing service 108 may include any computing device capable of connecting to network 105 to employ a rebate mechanism useable to reward at least one user of service provider 106 for performing fee generating transactions with service provider 106. Marketing service 108 may receive the rebate mechanism from service provider 106, along with a mechanism useable to select the at least one user. Marketing service 108 may then access a user database from service provider 106 from which to randomly select the at least one user to receive the rebate. In one embodiment, marketing service 108 may be configured to maintain the user database for service provider 106. Marketing service 108 may then provide the rebate to the selected user. In one embodiment, marketing service 108 may be used in conjunction with service provider 106 to register new users to service provider 106. Marketing service 108 may employ a process such as described below in conjunction with FIG. 5 to perform at least some of its actions.

Devices that may operate as marketing service 108 include personal computers desktop computers, multiprocessor systems, microprocessor-based or programmable consumer electronics, network PCs, servers, and the like.

Although FIG. 1 illustrates marketing service 108 as a single computing device, the invention is not so limited. For example, one or more functions of marketing service 108 may be distributed across one or more distinct computing devices. Moreover, marketing service 108 and service provider 106 need not be implemented within separate network devices, and may instead, in one embodiment, be implemented with the same network device. Alternatively, components of marketing service 108 and/or service provider 106 may be distributed across a plurality of network devices, without departing from the scope of the invention.

It should also be noted that users of service provider 106 are not constrained to making purchase transactions with service provider 106 over network 105. For example, a user of service provider 106 may employ a postcard, or other form of postal mailing service to request a purchase from service provider 106. Moreover, the invention is not limited to these forms of purchase transactions. For example, a user of service provider 106 may also walk into a facility of service provider 106 and perform a purchase transaction “on-site” of the business of service provider 106, or even employ Plain Old Telephone Services (POTS), without departing from the scope of the invention. Thus, the invention should not be construed to being constrained to network 105 transactions, and other forms of purchase transaction mechanisms may also be employed by a user. Moreover, marketing service 108 may also provide rewards to a purchasing user of service provider 106 over any of a variety of mechanisms beyond network 105, including, postal mail services, or the like.

### Illustrative Client Device

FIG. 2 shows one embodiment of client device 200 that may be included in a system implementing the invention. Client device 200 may represent one embodiment of client devices 101-103 of FIG. 1. However, the invention is not constrained to this embodiment, and other implementations, computing devices, or the like, may also be used, without limiting the scope of the invention.

Client device 200 may include many more or less components than those shown in FIG. 2. However, the components shown are sufficient to disclose an illustrative embodiment for practicing the present invention. As shown in the figure, client device 200 includes a processing unit 222 in communication with a mass memory 230 via a bus 224.

Client device 200 also includes a power supply 226, one or more network interfaces 250, an optional audio interface 252, a display 254, a keypad 256, an illuminator 258, an input/output interface 260, an optional haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, and the like.

Audio interface 252 is arranged to produce and receive audio signals such as the sound of a human voice, music, or the like. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Client device 200 may further include additional mass storage facilities such as optical disk drive 228 and hard disk drive 227. Hard disk drive 227 is utilized by client device 200 to store, among other things, application programs, databases, and the like. Additionally, optical disk drive 228 and hard disk drive 227, a flash memory, or the like may store cookies, data, images, or the like.

Keypad 256 may comprise any input device arranged to receive input from a user (e.g. a sender). For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, mouse, stylus, or other input or output devices. Input/output interface 260 can utilize one or more communication technologies, such as USB, infrared, Bluetooth™, and the like. Optional haptic interface 262 is arranged to provide tactile feedback to a user (e.g. a sender) of the client device. For example, the optional haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS and the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® operating system. The operating system may include an interface with a Java virtual machine module that enables control of hardware components and/or operating system operations via Java application programs.

Memory 230 further includes one or more data storage 242, which can be utilized by client device 200 to store, among other things, programs 244 and/or other data. For example, data storage 242 may also be employed to store information that describes various capabilities of client device 200. The information may then be provided to another device based on any of a variety of events, including being sent as part of a header during a communication, sent upon request, and the like. Moreover data storage 242 may be used to store information such as data received over a network from another computing device, data output by a client application on client device 200, data input by a user of client device 200, or the like. For example, data storage 242 may include data, including cookies, and/or other client device data sent by a network device. Data storage 242 may also include image files, or the like, for display and/or use through various applications. Data storage 242 may also include received messages, attachments to messages, as well as messages to be sent to another computing device, or the like. Moreover, although data storage 242 is illustrated within memory 230, data storage 242 may also reside within other storage mediums, including, but not limited to optical disk drive 228, hard disk drive 227, or the like.

Programs 244 may also include computer executable instructions which, when executed by client device 200, transmit, receive, and/or otherwise process messages and enable telecommunication with another user of another client device. Other examples of application programs include calendars, contact managers, task managers, transcoders, database programs, word processing programs, security programs, spreadsheet programs, games, CODEC programs, and so forth. In addition, mass memory 230 stores browser 246, and messenger 272.

Browser 246 may be configured to receive and to send web pages, forms, web-based messages, and the like. Browser 246 may, for example, receive and display (and/or play) graphics, text, multimedia, audio data, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like.

Messenger 272 may be configured to initiate and manage a messaging session using any of a variety of messaging communications including, but not limited to email, Short Message Service (SMS), Instant Message (IM), Multimedia Message Service (MMS), internet relay chat (IRC), mIRC, and the like. For example, in one embodiment, messenger 272 may be configured as an IM application, such as AOL Instant Messenger, Yahoo! Messenger, .NET Messenger Server, ICQ, or the like. In one embodiment messenger 272 may be configured to include a mail user agent (MUA) such as Elm, Pine, MH, Outlook, Eudora, Mac Mail, Mozilla Thunderbird, or the like. In another embodiment, messenger 272 may be a client application that is configured to integrate and employ a variety of messaging protocols.

Using browser 246 and/or messenger 272, a user of client device 200 may interact with another network device to make purchases of products, services, or to perform other types of purchase transactions with a business. In one embodiment, the user may provide the fees for the purchases through various authorizations using browser 246 and/or messenger 272. The user may, in one embodiment, also pay invoices, and/or receive rebates, or other types of commissions, rewards, or the like, using browser 246 and/or messenger 272.

### Illustrative Server Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, marketing service 108 of FIG. 1. It should be recognized that the invention is not limited to the use of a network device as described below, and other computing devices may also be used. For example, in one embodiment, marketing service 108 may be implemented within a mainframe computing device, peer-to-peer computing devices, or the like, without departing from the scope of the invention. Thus, network device 300 is not to be construed as limiting the invention, but merely provides one possible implementation among a plurality of non-exhaustive possible implementations.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management, application programming interfaces (APIs), web servers, and so forth. Mass memory also includes user data store 352 and market manager 356.

User data store 352 is configured and arranged to manage and store information associated with a user of a service provider, such as service provider 106 of FIG. 1. As such, user data store 352 may include a user name, account number, user alias, user address, a client device identifier associated with a user, a mailing address, telephone number, email address, or the like. In one embodiment, user data store 352 may also include information about a user's purchase, including, but not limited to an amount of purchases, when a user first made a purchase or signed up to receive a service/product from the service provider (a length of service with the service provider), an amount of revenue generated by the user, or the like. User data store 352 may also include information indicating whether the user is a new user to the service provider, whether the user has maintained a defined service level, or made a defined level of purchases, or purchases that exceeded a defined amount of money, or the like. User data store 352 may be implemented using any of a variety of mechanisms, including, but not limited to a database, a spreadsheet, files, a program, or the like. As such, user data store 352 may be implemented, in one embodiment, using an Oracle database, Sqlserver, MySql, or the like. However, the invention is not so limited, and other database implementations may also be used, including virtually any implementation, product, or the like, using a relational model, a hierarchical model, or even a network model, without departing from the scope of the invention.

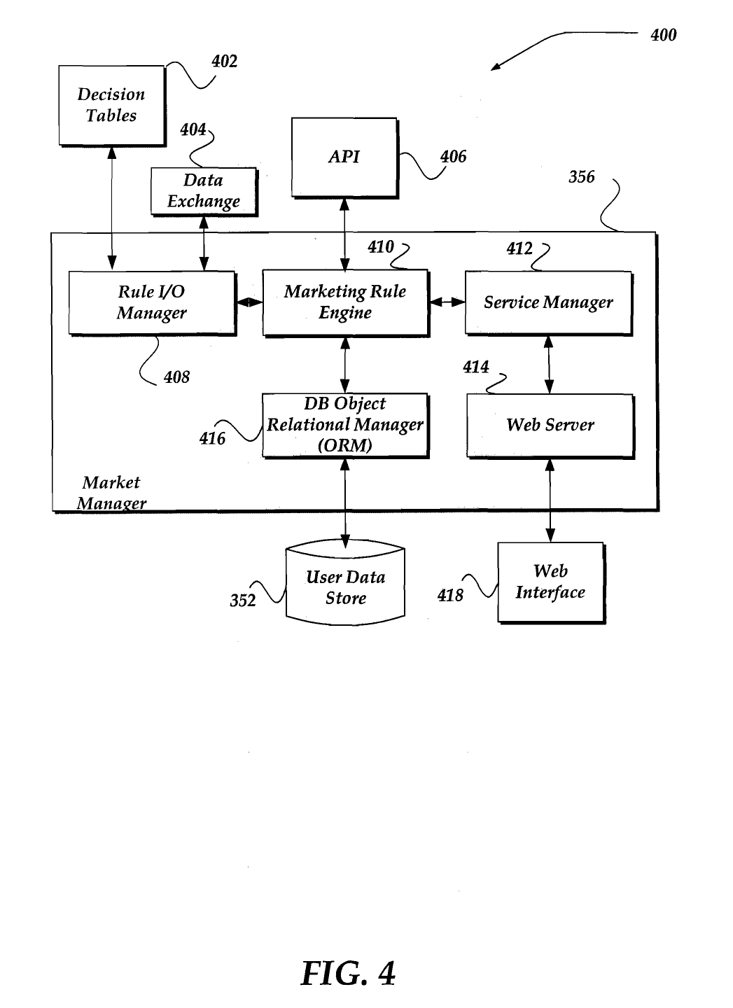

One embodiment of market manager 356 is described in more detail below in conjunction with FIG. 4. Briefly, however, market manager 356 is configured and arranged to provide and process rules and actions to fully support the random selection marketing and rebates for a service provider. Various criteria, and/or other mechanisms may be provided to market manager 356 for use in determining a rebate percentage to be provided to at least one user of the service provider. Moreover, various criteria and/or other mechanisms may be provided for use in determining at least one randomly selected user from within a plurality of users of the service provider.

In one embodiment market manager 356 may employ user data store 352 to randomly select the at least one user to receive the rebate. In one embodiment, the rebate may be provided over a network. However, the invention is not so limited. For example, selection of the at least one user may also be performed manually using a variety of mechanisms, including a lottery ball selection mechanism, random selection from a box, hat, or the like, without departing from the scope of the invention. Moreover, the rebate may also be provided using a variety of mechanisms, including, for example, through postal mail, or the like. In one embodiment, the rebate may also be reflected as a reduction in fees to be paid in the future by the selected user.

As noted above, the user may be selected based on a variety of criteria. For example, section of the at least one user may be based on a variety of criteria, including a duration over which the user has performed transactions with the business, a number of users that have selected to perform transactions subsequent to participation by the user, or the like. For example, in one embodiment, users that have participated in transactions for more than a period of time might be selected as a subgroup from which one or more users might then be randomly selected to receive the rebate. In another embodiment, users that make purchases over a defined amount of money might also be defined as a subgroup from which one or more users might then be selected to receive the rebate. In still another embodiment, a number might be randomly selected that may be used to identify one or more users. For example, the number might indicate a single user, or might indicate that every Nth user might receive the rebate, where N is the randomly selected number.

Moreover, the rebate determination mechanism might be based on a variety of criteria. For example, a rebate might be based on a percentage of revenue generated by a subgroup of users. The subgroup of users might those that registered for or agreed to purchase a product or service from the service provider subsequent to the selected user. The rebate could also be based on a percentage of revenues obtained from purchase transactions by all of the active users of the service provider. In still another embodiment, the rebate could be determined based on a randomly determined percentage of revenue from at least a subgroup of users. In one embodiment, the randomly determined percentage of revenue could be range limited, so as not to exceed a defined amount. It should be clear that the rebate determination may be based on virtually any criteria, and therefore is not limited to or otherwise by the examples provided herein. Similarly, the user selection criteria is not limit to or otherwise by the examples so provided.

### Generalized Architecture

FIG. 4 shows one embodiment of a possible architecture for a marketing manager. System 400 of FIG. 4 may include many more or less components than those shown. However, the components shown are sufficient to disclose an illustrative embodiment for practicing the present invention. Moreover, the invention is not constrained to system 400, and other embodiments may also be used, without departing from the scope of the invention.

As shown in the figure, system 400 includes market manager 356, decision tables 402, data exchange 404, API 406, user data store 352, and web interface 418.

Generally, system 400 is arranged to provide a robust and dynamic environment to flexibly respond to differing needs of a service provider for providing rebates. The system is configured and arranged to process rules and provide actions to fully support the generation of a rebate to a randomly selected user of a business such as provided by service provider 106 of FIG. 1.

Rules may be introduced to market manager 356 through a rule I/O manager module 408. The rule I/O manager 356 may ingest a variety of formatted rules, including excel/comma separated value (CSV) type of files, or the like. In one embodiment, the files may be provided using a provided template or through a data exchange such as XML using a well defined data structure, or the like.

Moreover, system 400 may provide API 406 for managing actions by market manager 356 through an external program, administrator, or the like. System 400 also is arranged to provide various other service modules as shown, which may be dynamically updated through the rules I/O manager 408, or a variety of other mechanisms. Also shown, market manager 356 may include, or otherwise, interact with a web server 414 that provides a web interface 418 to enable users and/or administrators to interact with or otherwise manage market manager 356.

As shown, decision tables 402 are configured to provide an administrator, or the like, the ability to define rules and/or resultant actions by market manager 356 without a code change. In one embodiment, the decision tables 402 may employ an excel-based set of tables, although the invention is not so limited, and other forms may also be used, including, but not limited to scripts, command lines, or the like.

Service manager 412 is configured and arranged to provide various support services for rule processing, engine external services, web content services, or the like. DataBase (DB) Object Relational Manager (ORM) 416 is configured to operate as an ORM to allow for interfacing with a variety of data store structures, including user data store 352, or the like.

### Generalized Operation

The operation of certain aspects of the invention will now be described with respect to FIG. 5. FIG. 5 illustrates a logical flow diagram generally showing one embodiment of a process for randomly selecting a user of a business to receive a rebate based, in part, on the user's usage of the business.

Process 500 of FIG. 5 begins, after a start block, at block 502, where a rebate mechanism is determined. In one embodiment, a service provider may determine the rebate mechanism, and provide it to a marketing service. In one embodiment, the service provider may employ a default rebate mechanism. However, in another embodiment, the service provider may select different rebate mechanisms based on some event, condition, or the like. For example, where the service provider determines that too many rebates are being provided, or too much of its revenue is being consumed in rebates, the service provider, or the like, might determine another rebate mechanism. The rebate mechanism may be determined based on a variety of the criteria including those mentioned above. However, the invention is not limited to the criteria mentioned, and virtually any rebate criteria may be employed to determine how much the rebate should be, when the rebate should be offered, or the like.

Processing then flows to block 504, where a selection mechanism is determined for randomly selecting at least one user to receive the rebate. As noted elsewhere, the selection mechanism may employ virtually any criteria by which at least one user may be randomly selected, including, but not limited to those mentioned above.

Process 500 then flows to decision block 506, where a determination is made whether a new user to the service provider is detected. Such determination may be made by receiving information, for example, from the service provider, or the user. For example, a user might initially request registration to participate in receiving the rebate. In any event, if a new user is detected, processing flows to block 508; otherwise processing branches to block 510.

At block 508, the new user is registered to participate in the marketing rebate. As noted, the user might request to be registered. In another embodiment, a user might be automatically registered to receive a rebate based on a purchase transaction, a request to receive a service, or the like. In one embodiment, a might be randomly selected to be registered to participate in process 500. Processing then flows to block 510.

At block 510, a user may employ the service, purchase a product, or otherwise perform a variety of other purchase transactions. Processing continues next to decision block 512, where a determination is made whether it is a next payout cycle. In one embodiment, rebates may be paid out based on a scheduled payout cycle, such as a billing cycle, based on a time period, or even some other event, condition, or the like. If it is determined to be a next payout cycle, processing flows to block 516; otherwise, processing branches to decision block 522.

At block 516, a user may be randomly selected from a plurality of users to be eligible for a rebate. In one embodiment, more than one user might be selected from the plurality of users. In another embodiment, as mentioned elsewhere, at least one user might be selected from a subgroup or subset of the plurality of users based on the selection mechanism provided at block 504. In one embodiment, the at least one user may be selected using an automated process. However, the selection may also be performed manually.

Processing continues to block 518, where the rebate mechanism is used to determine the rebate amount to be paid out to the selected at least one user from block 516. Processing flows next to block 520, where the rebate may be sent to the at least one selected user, using any of a variety of mechanisms, including those identified above. Moreover, it should be clear that the rebate may also be provided through or into any of a variety of mechanisms, including, but not limited to providing the rebate into an Individual Retirement Account (or IRA), a college fund, or virtually any other account structure or arrangement. In one embodiment, the rebate may even be provided through coupons for purchases of products or services from another business, or even the same business.

Process 500 flows next to decision block 522, where a determination is made whether the selection mechanism is to be modified. If so, processing branches back to block 504; otherwise, processing continues to decision block 524. At decision block 524, a determination is made whether the rebate mechanism is to be modified, and if so, processing loops back to block 502; otherwise, processing loops back to decision block 506.

Process 500 may continue to be performed based on a service provider until the service provider or other administrator elects to terminate the process. The process may then return to a calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps or combinations of special purpose hardware and computer instructions.

### ILLUSTRATIVE EXAMPLES

As noted, the present invention is configured to enable a business that charges a fee for its product or service to potentially increase a number of users they service, decrease user attrition rate, increase urgency for using their service, gain customer loyalty and provide their users with an opportunity to receive rebates with minimal business recruiting, advertising, or the like

As each new user registers for a service, product, or the like, or otherwise is registered, the user may become immediately eligible to be randomly selected to receive a rebate based on revenues obtained from other than just the user. In one embodiment, the invention may be configured to put new users as commissioned rebate accounts under an existing user, such that a user might be able to receive rebates based on subsequent users to the business. This arrangement may further reduce attrition, and minimize user jumping to capture rewards for initially joining a business. There are a plurality of different businesses that may benefit from such an invention.

For example, the deregulated energy market is an area where a company who implements the present invention might benefit. Almost everyone uses an electricity provider. In some states, the state may provide a website, to allow its residents to find a company that best matches their energy needs. There may be large companies, who get a premium for their service because of size and name recognition. On the other end of the spectrum there may be companies that cut costs as much as possible to provide the user with the lowest bottom line pricing. Thus, there appears to be two selling points, in this instance, cost vs. name recognition. If however, one of the ‘middle’ companies used the present invention, not only might they survive, they might even become more successful, as users spread the word about the rebates.

In this example, the person to which an account might be assigned might be determined by a random process chosen by the company offering the rebate. Implementation could be as simple as drawing names from a hat or as sophisticated as a real-time viewable software program. In one embodiment, a stipulation may be placed that a given service level must be maintained in order to qualify for a rebate. In another embodiment, a length of service may also be placed upon a user to be eligible, although this need not be used in another embodiment. Thus, in one embodiment, a new user to the service could have an equal chance or their name/account being randomly selected for new account assignment and rebate and any other active user.

While online gambling may be illegal in some regions of the world, the situation might change over time. Thus, another example of use might be online gambling, where legal. In online gambling, it is typically the consumer/user that is constantly searching for the best deal. Thus, in the online gambling scenario, the company may offer the consumer the additional chance of winning a percentage of a fee or other purchase transaction back, which the user was willing to already invest during playing the game. Thus, the consumer could win by doing something they were looking to do or already are doing. In fact, the use of the present invention might be viewed by some consumers as ad added game.

In still another example, a business might be configured and arranged to offer rebates based on business transactions by a plurality of users of a credit card, or the like. By recognizing that one might receive a rebate based, in part, on transactions by others, a sense of urgency might be created to participate. It should be noted, however, that use of the present invention is not limited to these examples, and virtually any business may be configured to employ the present invention.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A network device for use in managing transactions over a network, comprising:
a transceiver to send and receive data over the network; and
a processor that is operative to perform actions, including:
employing a selection mechanism to randomly select a user from among a plurality of users of a business;
determining a rebate mechanism based, in part, on transactions by the plurality of users with the business;
employing the rebate mechanism to determine a rebate; and
providing the selected user the rebate.

2. The network device of claim 1, wherein determining the rebate mechanism further comprises determining a percentage of revenues obtained from purchase transactions by the plurality of users.

3. The network device of claim 1, wherein determining the rebate mechanisms further comprises determining a percentage of revenues obtained from purchase transactions by those users among the plurality of users that became users to the business after the selected user became a user to the business.

4. The network device of claim 1, wherein employing a selection mechanism to randomly select a user further comprises randomly selecting the user from among a subset of users selected from the plurality of users, wherein the subset is based on at least one of a length of service with the business or a level of purchases made.

5. The network device of claim 1, wherein the transactions are performed over a network between a client device and another network device.

6. The network device of claim 1, wherein determining a rebate mechanism further comprises determining the rebate based on transactions performed by a subset of the plurality of users, and wherein employing a selection mechanism further comprises selecting a user from a subset of the plurality, each user in the subset having generated at least a defined amount of revenue.

7. The network device of claim 1, wherein the transactions further comprises conducting a purchase of at least one of a product or a service from the business.

8. A system for managing transactions over a network, comprising:
a plurality of client devices, wherein each client device is associated with a user within a plurality of users, and each client device being configured and arranged to perform actions, including:
enabling the respective user of the client device to perform a purchase transaction over the network; and
a server component in communication with the plurality of client devices, and configured and arranged to perform actions, including:
determining a selection criteria useable to randomly select a user within the plurality of users;
randomly selecting at least one user among the plurality of users using the selection criteria;
determining a rebate based on transactions with the business by at least two users among the plurality of users; and
sending the rebate to the selected at least one user at a determined time period.

9. The system of claim 8, wherein the server component is configured and arranged to perform actions, further comprising:
selecting at least one other user among another plurality of users using the selection criteria;
determining another rebate based on a percentage of purchase transactions by at least two other users among the other plurality of users; and
sending the other rebate to the select at least one other user at another determined time period.

10. The system of claim 8, wherein randomly selecting at least one user further comprises randomly selecting the at least one user from a subgroup of the plurality of users, wherein the subgroup of users is determined based on at least one of an overall financial purchase amount by a user within the subgroup exceeding a determined amount or based on length of time a user has been performing purchase transactions with the business.

11. The system of claim 8, wherein determining the rebate further comprises:
determining a number of users within the plurality of users that have a first purchase transactions after a first purchase transaction of the selected at least one user;
determining a percentage of revenues from purchase transactions of the determined number of users; and
distributing the determined percentage of revenues among the selected at least one user.

12. The system of claim 8, wherein the purchase transactions further comprises purchasing at least one or a service or a product.

13. The system of claim 8, wherein the server component is configured and arranged to perform actions, further comprising registering users to be among the plurality of users eligible for being randomly selected.

14. The system of claim 8, wherein selecting at least one user further comprises randomly selecting the at least one user from a subset of the plurality of users, wherein each user within the subset has generated at least a defined amount of revenue within a defined time period.

15. A processor readable medium that includes instructions stored thereon, wherein the execution of the instructions by a computer device provides for managing transactions over a network, the instructions comprising:
enabling a plurality of users to perform purchase transactions with a business;
randomly selecting a user from among the plurality of users;
determining a rebate based on the purchase transactions with the business by at least a subset of users among the plurality of users; and
sending the rebate to the selected at least one user at a determined time period.

16. The processor readable medium of claim 15, wherein randomly selecting the at least one user further comprises selecting the at least one user based on one of detecting a new user to the business or a billing cycle.

17. The processor readable medium of claim 15, wherein randomly selecting the at least one user further comprises randomly selecting the at least one user from a subgroup of the plurality of users, wherein the subgroup of users is determined based on at least one of an overall financial purchase amount by each user within the subgroup exceeding a determined amount or based on length of time a user has been performing purchase transactions with the business.

18. The processor readable medium of claim 15, wherein determining the rebate further comprises determining a percentage of revenues obtained from purchase transactions by those users among the plurality of users that became a user to the business after the selected at least one user became a user to the business.

19. The processor readable medium of claim 15, wherein determining a rebate further comprises determining the rebate based on a percentage of revenue based in part on at least one of a length of service with the business or a level of purchases made by the selected user.

20. The processor readable medium of claim 15, wherein randomly selecting the user is independent of a length of service with the business by the user.
